(19) United States
(12) Patent Application Publication
(10) Pub. No.: US 2002/0109730 A1
(43) Pub. Date: Aug. 15, 2002

(54) System and method for an on-demand script-activated selection dialog control

(75) Inventor: Glenn Dardick, Maidens, VA (US)

Correspondence Address: Greenberg Traurig, LLP, 12th Floor, 1750 Tysons Boulevard, McLean, VA, 22102, US

(73) Assignee: Dardick Technologies, Richmond, VA (US)

(21) Appl. No.: 09/865,490

(22) Filed: May 29, 2001

Related U.S. Application Data
(60) Provisional application No. 60/207,241, filed on May 26, 2000.

(51) Int. Cl. G09G 5/00

(52) U.S. Cl. 345/809

(57) ABSTRACT

A system and method for an improved dialog box which may be used in lieu of a traditional, operating system generated dialog box. Properties, methods, and hooks may be exposed by the present invention which allow programmers and web designers to create custom applications based on the present invention while customizing the behavior of the present invention to suit specific user-interface requirements.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

This application claims the benefit of U.S. Provisional Patent Application No. 60/207,241 filed on May 26, 2000, the entire disclosure of which is incorporated herein by reference

This application is related to U.S. Pat. application Ser. No. 09/721,511 filed Nov. 22, 2000 and further related to U.S. Patent Application filed May 29, 2001 titled “System and Method For a Field Type Intelligent Web Portal” by inventor Glenn Dardick”; and U.S. Patent Application filed May 29, 2001 titled “System and Method For an On-Demand Script Activated Virtual Keyboard” by inventor Glenn Dardick, the entire disclosures of which are incorporated herein by reference

### FIELD OF THE INVENTION

The present invention relates to the field of computer interface design, and, in particular, the present invention provides a script-activated selection dialog box which may be activated through a touch-screen.

### BACKGROUND OF THE INVENTION

Computers are becoming increasingly prolific. From handheld organizers to notebook computers to Automated Teller Machines (ATMs) to information kiosks, computers are all around us. However, as computers continue to permeate our society, one overriding problem remains: how to create more intuitive human/computer interfaces.

For many years, keyboards and pointing devices, such as joysticks and mice, have been preferred for allowing humans to interact with computers. However, such input mechanisms require a significant learning curve, and are thus not well suited for devices such as kiosks and ATM machines which are used by the general public. The need for a more intuitive user-interface element has spurred the development of touch-sensitive display devices, such as that taught by U.S. Pat. No. 5,777,596 to Herbert.

As touch-sensitive displays have become increasingly popular, those designing handheld devices, kiosks, ATMs, and the like have created unique user-interfaces which structure interaction around visual elements on a touch-sensitive display. However, one problem consistently experienced by the prior art is the use of operating system level controls. Standard controls available from an operating system, such as dialog boxes, are of a size determined by the operating system.

Touch-screen displays typically use displays at low resolutions; this is to allow larger dialog boxes to be displayed, thus making it easier for visually or physically impaired individuals to properly interact with a kiosk or ATM.

It is often desirable for kiosk and ATM designers to utilize higher resolution displays, as more information can be displayed in a smaller area. Utilizing higher resolution displays would allow, for example, the display of a higher-resolution picture, the display of additional text, and the ability to create a more comfortable user interface through creative boarders and other such elements. Such usability enhancements are not available at lower resolutions, due to the decreased screen display area available.

### SUMMARY OF THE INVENTION

The present invention improves upon the prior art by enhancing the usability of existing technologies when applied to touch-screen displays. In particular, the present invention allows creation and control of dialog boxes whose display size depends on display resolution and display dimensions, rather than operating at a fixed size.

The present invention allows software developers to utilize existing software, such as web browsers, without the need to create such dialog boxes for each instance in which they are used. The present invention may further allow software developers to incorporate larger dialog boxes into custom developed applications, further improving over the prior art.

The present invention utilizes software developed in a standardized programming language, such as, but not limited to JAVA or C++, to draw a dialog box on a display device and to read user input from such a device. The present invention may further be structured to allow access and control of the present invention by other software or hardware.

Such control may include, but are not limited to, displaying or hiding a dialog box, selecting text to appear within actionable regions (“buttons”) or other areas of a dialog box, selecting the number of buttons to be displayed, indicating a default button, choosing images (“icons”) to be displayed in a dialog box, and controlling dialog box and button colors.

### BRIEF DESCRIPTION OF THE DRAWINGS

FIG. 1 is a screen capture illustrating a traditional kiosk touch-screen which includes a color selection field.

FIG. 2 is a screen capture illustrating a traditional kiosk touch-screen to which the present invention has been added.

FIG. 3 is a screen capture illustrating a traditional kiosk touch-screen with a color selected in the color selection field.

### DETAILED DESCRIPTION OF THE PREFERRED EMBODIMENT

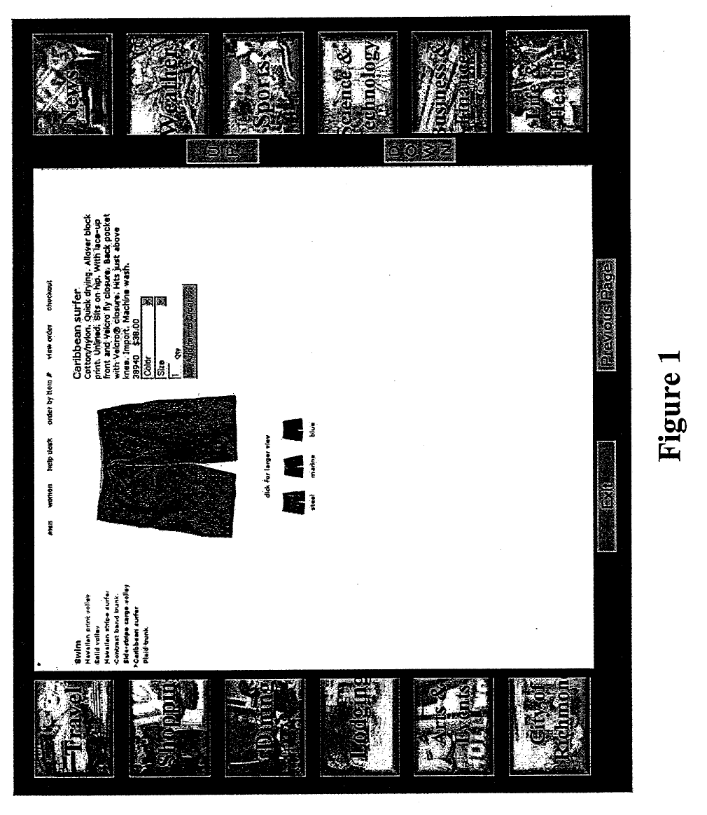

FIG. 1 is a screen capture illustrating a traditional kiosk touch-screen which includes a color selection field. In a preferred embodiment, a user wishing to select a desired clothing color may touch the screen in the area of the color selection field.

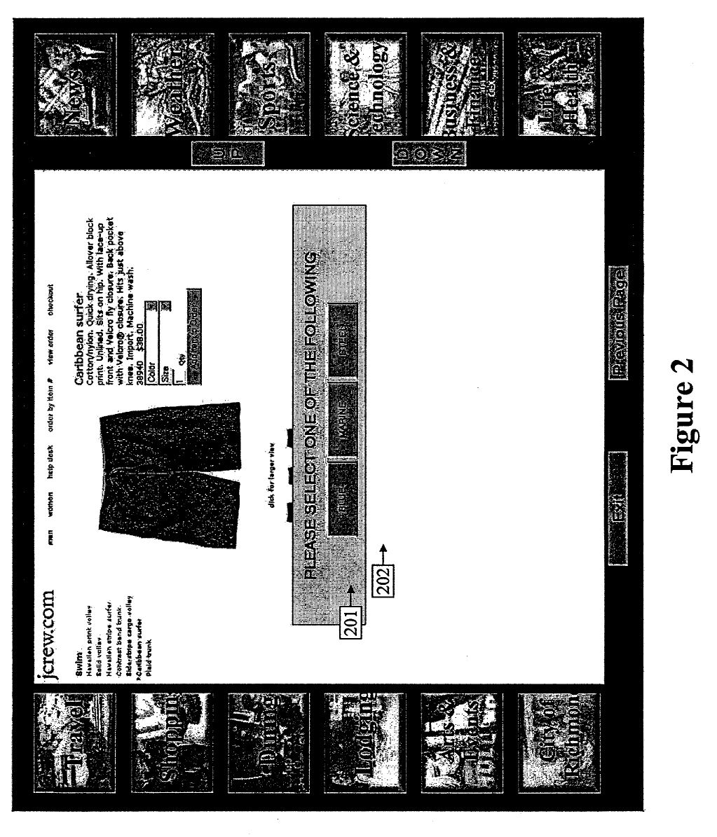

A software developer or web page designer may specify that the present invention should be displayed when a user interacts with a touch-screen display and selects a field from which one of a plurality of available choices could be chosen. FIG. 2 is a screen capture illustrating a traditional kiosk touch-screen, on which the present invention is displayed.

As illustrated by FIG. 2, the present invention includes a dialog box which may dynamically resize based on display resolution. In addition, fonts, icons, and other information within a dialog box may also be scaled proportionately.

Such dynamic resizing represents an improvement over the prior art by allowing software developers and web page designers to create user interfaces which take advantage of the larger display area available at higher resolutions, without worrying about making dialog box buttons too small to be easily activated by a user at a touch-screen. By way of example, without intending to limit the present invention, a 1024 pixel by 768 pixel (“1024×768”) display has over 2.5 times the display area of a 640 pixel by 480 pixel (“640×480”) display. However, most kiosk and ATM designers limit their designs to 640×480 displays because operating system dialog boxes are 2.5 times smaller on a 1024×768 display, and are therefore more difficult for visually or physically impaired individuals to properly interact. The present invention allows a kiosk or ATM designer to utilize a 1024×768 (or higher resolution) display, while still presenting users with dialog boxes with buttons, text, icons, and the like which can be easily read and with which a user may easily interact.

The present invention also represents an improvement over dialog boxes taught by the prior art in other ways. For example, in a preferred embodiment, the present invention may take the form of a computer program written in a standardized programming language such as JAVA, C++, or Visual Basic, and may be distributed as a code library. Such a distribution method may allow the present invention to be easily incorporated into other software, or added to web pages in the form of JAVA applets, ActiveX controls, or other such enhancements.

The present invention may further improve upon prior dialog boxes by seamlessly integrating with a web browser or other software. For example, the present invention may be automatically launched by a web browser when a user activates a field, or when a script or other software requests information from a user. Further, the present invention may read attributes associated with a <SELECT> HTML tag, scripted procedure call, or other user input mechanism and automatically configure available buttons, default buttons, and other dialog box features based on such attributes.

As illustrated by Block 201 of FIG. 2, the present invention may also include a text display area. Such a text display area may have a default value, as illustrated in FIG. 2, and the content of such a text display area may be modified by a software developer or web page designer.

The present invention may further contain one or more buttons, with each button containing text, images, or a combination of text and images, as illustrated by Block 202. If desired, a software developer or web page designer may specify a button which is to be outlined or otherwise differentiated from other buttons on a dialog box, thereby indicating a default or recommended choice, and improving the quality of the overall user-interface.

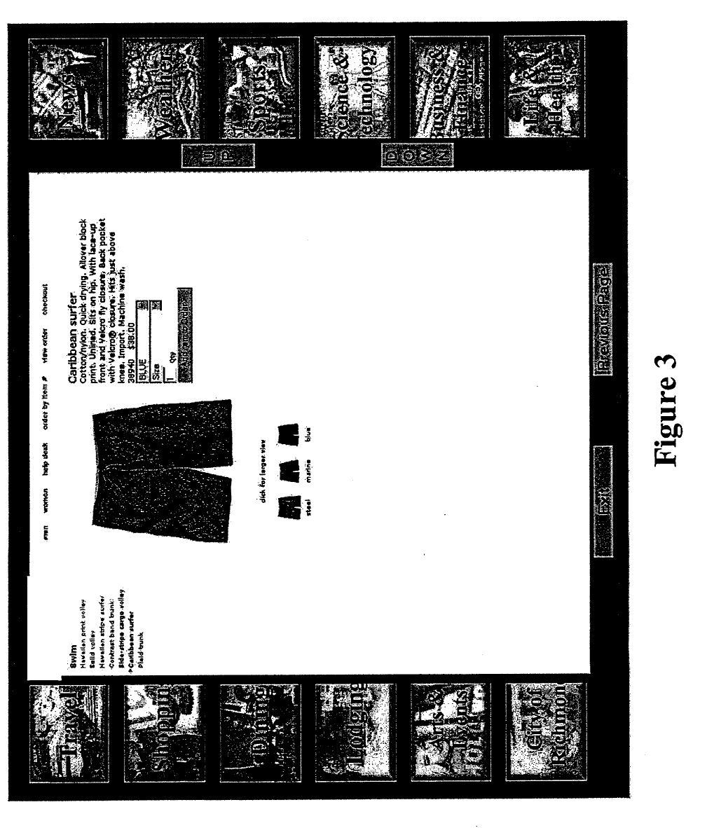

Once a user has chosen from the options available on a dialog box, the present invention may return the submitted information to the controlling application or web page, as illustrated by FIG. 3. FIG. 3 is a screen capture illustrating a traditional kiosk touch-screen with data entered in the color choice field.

Appendix A shows an example of source code which is useful for practicing the present invention in accordance with a preferred embodiment. The present invention is particularly useful in combination with publicly accessible kiosks such as that taught in U.S. Pat. application Ser. No. 09/721,511 filed Nov. 22, 2000, the entire disclosure of which is incorporated herein by reference.

As should be apparent to one skilled in the art, the preceding discloses an improved touch-screen based dialog box control. Although others in the prior art have utilized touch-screen based dialog boxes, the present invention improves upon the prior art by providing a platform-independent, software based dialog box which can be easily configured to match specific user-interface requirements.

While the preferred embodiment and various alternative embodiments of the invention have been disclosed and described in detail herein, it will be apparent to those skilled in the art that various changes in form and detail may be made therein without departing from the spirit and scope thereof.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

I claim:

1) In a computer system operable with selection controls, a system for an on-demand script-activated selection dialog comprising:
a control, whereby a selection dialog is activated in response to the activation of a control; and
a selection dialoge, which is dynamically resized based upon display resolution.

2) The selection dialog of claim 1, wherein the selection dialog is configurable by reading the control's attributes.

3) The selection dialog of claim 1, wherein the selection dialog is platform independent.

4) The selection dialog of claim 1, wherein the selection dialog is distrubutable as a code library.

5) The selection dialog of claim 1, wherein the selection dialog is configurable; and

6) The selection dialog of claim 1, wherein routines provide for the return of data to the underlying application.

7) In a computer system operable with selection controls, a method for an on demand script-activated selection dialog comprising:
activating a selection dialog, in response to the activation of a control; and
resizing the selection dialogue based upon display resolution.

8) A method according to claim 7, wherein the selection dialog is configurable by reading the control's attributes.

9) A method according to claim 7, wherein the selection dialog is platform independent.

10) A method according to claim 7, wherein the selection dialog is distributable as a code library.

11) A method according to claim 7, wherein the selection dialog is configurable.
